(19) United States
(12) Patent Application Publication
(10) Pub. No.: US 2016/0004583 A1
(43) Pub. Date: Jan. 7, 2016

(54) SYSTEM FOR PROJECT MANAGEMENT FROM NON-FUNCTION EVALUATION, METHOD FOR PROJECT MANAGEMENT FROM NON-FUNCTION EVALUATION, AND PROGRAM FOR PROJECT MANAGEMENT FROM NON-FUNCTION EVALUATION

(71) Applicant: NEC CORPORATION, Tokyo (JP)

(72) Inventor: Hiroshi SAKAKI, Tokyo (JP)

(73) Assignee: NEC Corporation, Tokyo (JP)

(21) Appl. No.: 14/766,812

(22) PCT Filed: Nov. 19, 2013
(86) PCT No.: PCT/JP2013/081194

§ 371 Date: Aug. 10, 2015

(30) Foreign Application Priority Data
Feb. 14, 2013 (JP) 2013-027088

(51) Int. Cl. G06F 11/07

(52) U.S. Cl. CPC G06F 11/079; G06F 11/0709; G06F 11/0751; G06F 11/0787

(57) ABSTRACT

Provided is a progress management technique for a project, the technique also covering a non-functional requirement of the project. A parameter required for evaluating the non-functional requirement is adjusted according to the progress of the project, and calculation is made, using the adjusted parameter, on to which extent the non-functional requirement may finally differ from a target value.

### TECHNICAL FIELD

The present invention relates to a project management system, a project management method, and a project management program, and in particular to a project management system based on non-functional evaluation, a project management method based on non-functional evaluation, and a project management program based on non-functional evaluation that allow the non-functional evaluation to be managed according to progress status of the project.

### BACKGROUND ART

Examples of conventional project management systems can be found in Patent Literature (PTL) 1 and PTL 2. The project management system according to PTL 1 is essentially configured as illustrated in FIG. 1.

A bug management system inputs bug management information such as the number of bugs found and the number of bugs fixed. A man-hour management system manages man-hours that have been invested. An aggregation system aggregates the bugs and the man-hours. A past case storage means stores information of past project management. An analysis system analyzes progress of the project based on the past cases and information aggregated by the aggregation system.

The conventional project progress management system configured as above operates as follows. The project progress management system receives the man-hours to be invested and man-hours consumed, from the man-hour management system. The project progress management system also receives the number of bugs found and the number of bugs fixed from the bug management system, and aggregates the information in the aggregation system. Then the project progress management system looks up the past cases based on variation of the number of bugs that have appeared, to thereby predict the number of bugs to be found thereafter and analyze the maturity of the project.

PTL 2 discloses a project management system that manages a non-functional requirement along with development of the project. The project management system according to PTL 2 includes an extraction unit that extracts the number of commands, the number of lines and execution time of a program, and an evaluation unit that compares the function and the execution time.

The conventional project progress management system configured as above operates as follows. The project progress management system extracts the number of commands and the number of lines of the program from the source code, halfway of the program development or upon completion thereof. The project progress management system also predicts the execution time of the program with reference to the past cases, based on the number of commands and the number of lines that have been extracted. Then, the project progress management system compares between the predicted execution time and a target execution time, and instructs modification of the program apart from the progress of the source code, when the predicted execution time is longer than the target time.

### CITATION LIST

### Patent Literature

[PTL 1] Japanese Unexamined Patent Application Publication No. 2006-039603

[PTL 2] Japanese Unexamined Patent Application Publication No. 2012-145987

### SUMMARY OF INVENTION

### Technical Problem

With the conventional technique cited above, however, the progress of the project in the aspect of the non-functional requirement is unable to be predicted. Whether the project has been completed has to be decided in view of not only whether the functions have been established, but also whether the all the components as a whole satisfy the non-functional requirements specified by the customer. Accordingly, the present invention provides a technique that allows progress management of a project, including evaluation of a non-functional requirement, to be performed.

### Solution to Problem

In an aspect, the present invention provides a project management system including a storage means for storing information of error that may be generated between a non-functional evaluation value of a system in an unfinished stage and a non-functional requirement of the finished system, as evaluation error information with respect to each degree of progress of the project, a system model acquisition means for acquiring a system model of the system, a non-functional requirement acquisition means for acquiring the non-functional requirement of the system, a progress input means inputting the degree of progress of the project, a non-functional evaluation parameter input means for inputting a non-functional evaluation parameter of the system corresponding to the degree of progress input, a non-functional evaluation parameter adjustment means for adjusting the input non-functional evaluation parameter with the stored evaluation error information corresponding to the input degree of progress, and a non-functional evaluation means for evaluating a non-functional factor of the system at the input degree of progress, on a basis of the adjusted non-functional evaluation parameter, the acquired system model, and the acquired non-functional requirement.

In another aspect, the present invention provides a project management method to be executed by an information processing system including a control unit, the method including storing, in the control unit, information of error that may be generated between a non-functional evaluation value of a system in an unfinished stage and a non-functional requirement of the finished system, as evaluation error information with respect to each degree of progress of the project, acquiring a system model of the system, acquiring the non-functional requirement of the system, inputting the degree of progress of the project in the control unit, inputting in the control unit a non-functional evaluation parameter of the system corresponding to the degree of progress input, causing the control unit to adjust the input non-functional evaluation parameter with the stored evaluation error information corresponding to the input degree of progress, and causing the control unit to evaluate a non-functional factor of the system at the input degree of progress, on a basis of the adjusted non-functional evaluation parameter, the acquired system model, and the acquired non-functional requirement.

In still another aspect, the present invention provides a program that causes a computer to work as a storage means for storing information of error that may be generated between a non-functional evaluation value of a system in an unfinished stage and a non-functional requirement of the finished system, as evaluation error information with respect to each degree of progress of the project, a system model acquisition means for acquiring a system model of the system, a non-functional requirement acquisition means for acquiring the non-functional requirement of the system, a progress input means for inputting the degree of progress of the project, a non-functional evaluation parameter input means for inputting a non-functional evaluation parameter of the system corresponding to the degree of progress input, a non-functional evaluation parameter adjustment means for adjusting the input non-functional evaluation parameter with the stored evaluation error information corresponding to the input degree of progress, and a non-functional evaluation means for evaluating a non-functional factor of the system at the input degree of progress, on a basis of the adjusted non-functional evaluation parameter, the acquired system model, and the acquired non-functional requirement.

### Advantageous Effects of Invention

According to the present invention, a technology that enables progress management of a project, including evaluation of a non-functional requirement, can be provided.

### BRIEF DESCRIPTION OF DRAWINGS

FIG. 1 is a block diagram illustrating a configuration of a conventional system.

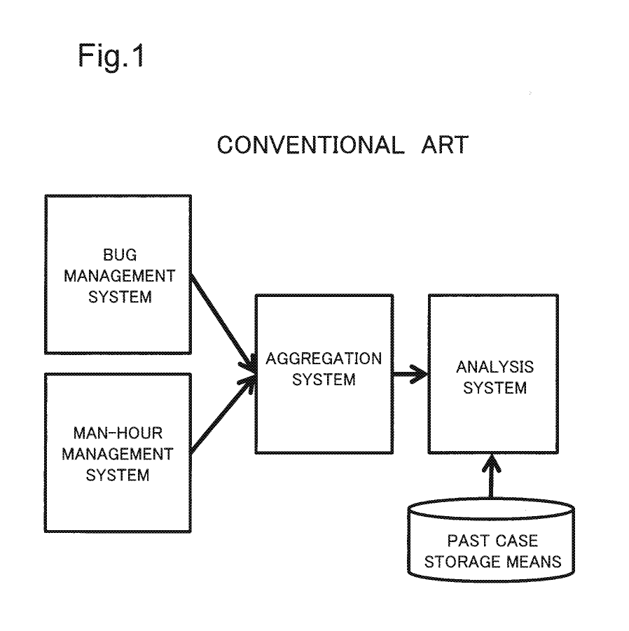

FIG. 2 is a block diagram illustrating a system configuration according to a first exemplary embodiment of the present invention.

FIG. 3 is a flowchart illustrating a process according to the first exemplary embodiment of the present invention.

FIG. 4 is a block diagram illustrating a system configuration according to a second exemplary embodiment of the present invention.

FIG. 5 is a flowchart illustrating a process according to the second exemplary embodiment of the present invention.

FIG. 6 is a block diagram illustrating a system configuration according to a third exemplary embodiment of the present invention.

FIG. 7 is a flowchart illustrating a process according to the third exemplary embodiment of the present invention.

FIG. 8 is a schematic diagram illustrating an example of a system model.

FIG. 9 is a graph illustrating a relation between degree of progress and error of each component.

FIG. 10 is a table illustrating examples of progress of each component.

FIG. 11 is a table illustrating examples of application information for non-functional evaluation.

FIG. 12 is a table illustrating examples of adjusted non-functional evaluation parameters.

FIG. 13 includes a table and a diagram illustrating an example of a non-functional evaluation result.

FIG. 14 is a graph illustrating a relation between degree of progress and project risk.

### DESCRIPTION OF EMBODIMENTS

Hereafter, exemplary embodiments of the present invention will be described in details with reference to the drawings.

### First Exemplary Embodiment

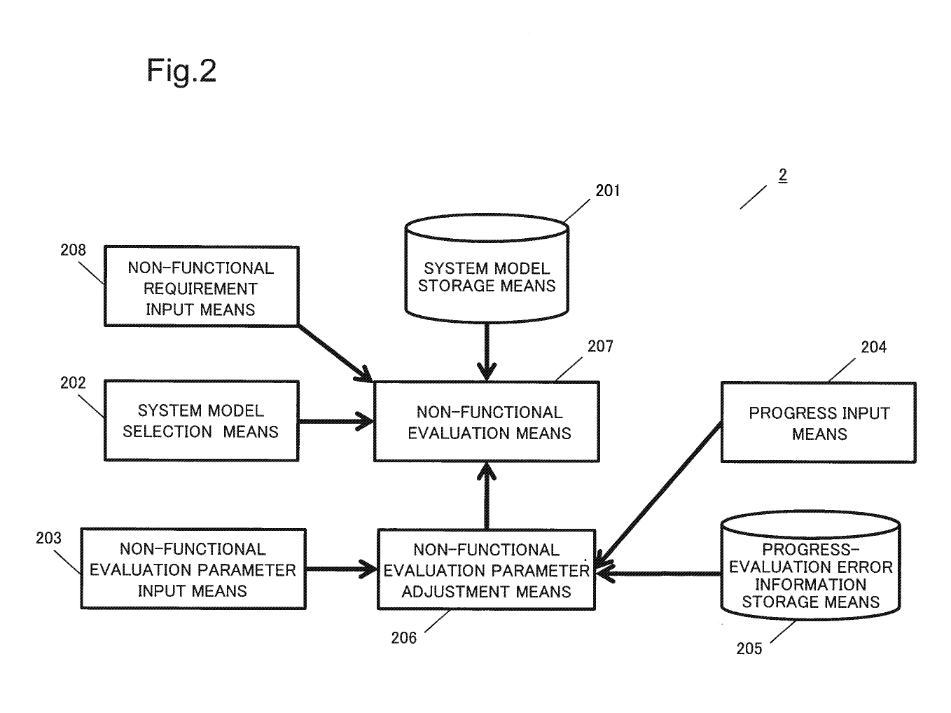

Referring to FIG. 2, the configuration of a project management system according to the first exemplary embodiment will be described. The project management system 2 includes a system model storage means 201, a system model selection means 202, a non-functional evaluation parameter input means 203, a progress input means 204, a progress-evaluation error information storage means 205, a non-functional evaluation parameter adjustment means 206, a non-functional evaluation means 207, and a non-functional requirement input means 208. Although not shown, the project management system 2 includes a hardware structure generally provided in information processing apparatuses, such as a control unit (e.g., a central processing unit (CPU)), memories (e.g., a random access memory (RAM) and a read only memory (ROM)), a storage device (e.g., a hard disk drive (HDD)), an operation unit (e.g., a keyboard and a mouse), and a communication unit. The functional configuration of the project management system 2 is realized, for example, by the control unit upon unfolding and executing a program stored in the memory or the storage device. This also applies to the project management system according to other exemplary embodiments.

In the system model storage means 201, system models are stored in advance. The system models each describe design information of the system such as a configuration of the system and data flow.

The system model selection means 202 selects a system model including the design information of the system to be constructed in accordance with the project. The system model that matches the configuration of the system to be constructed is selected out of the system models stored in the system model storage means 201. In the case where a desired system model is unavailable in the system model storage means 201, or the system model storage means 201 itself is unavailable, the system model selection means 202 may select a system model directly input in the project management system.

The non-functional evaluation parameter input means 203 receives an input of a parameter for non-functional evaluation (non-functional evaluation parameter) necessary for evaluating the non-functional factor of the system to be developed using the system model selected by the system model selection means 202. The non-functional evaluation parameter input means 203 then transmits the non-functional evaluation parameter to the non-functional evaluation parameter adjustment means 206. The non-functional evaluation parameter includes information necessary for evaluating the non-functional factor, for example operation information of an application such as a CPU load, and workload information such as the number of users.

The progress input means 204 receives an input of degree of progress of the project, and outputs the degree of progress to the non-functional evaluation parameter adjustment means 206.

The progress-evaluation error information storage means 205 stores progress-evaluation error information. The progress-evaluation error information represents how much error the non-functional evaluation may have with the progress of the project, thus indicating the impact that may be imposed on the degree of progress and the non-functional evaluation. To be more detailed, the progress-evaluation error information indicates, with respect to each degree of progress of the project, to which extent an evaluation value, obtained through evaluation of the non-functional factor of an unfinished system (i.e., system at a predetermined process/degree of progress halfway of the development) based on the input non-functional evaluation parameter, may differ from the non-functional requirement of the finally completed system. The progress-evaluation error information varies depending on a type of components of the system and degree of progress of the project. Here, the progress-evaluation error information may contain a function that decreases with the progress of the project.

The non-functional evaluation parameter adjustment means 206 retrieves the progress-evaluation error from the progress-evaluation error information storage means 205 based on the input degree of progress, and adjusts the non-functional evaluation parameter based on the progress-evaluation error. The adjusted non-functional evaluation parameter includes information of an upper limit value and a lower limit value that the non-functional evaluation parameter may assume when the system is completed, in the case where the non-functional evaluation parameter corresponds to the value input at the input degree of progress.

The non-functional requirement input means 208 receives an input of the non-functional requirement of the system to be developed (target value of the non-functional parameter), and outputs the non-functional requirement to the non-functional evaluation means 207.

The non-functional evaluation means 207 evaluates the non-functional factor based on the selected system model (e.g., information related to the connection of the system), the adjusted non-functional evaluation parameter and the non-functional requirement, and outputs the evaluation result. Here, the non-functional evaluation means 207 may also perform the non-functional evaluation using the unmodified non-functional evaluation parameter, and output the evaluation result together with the non-functional evaluation result calculated based on the adjusted non-functional evaluation parameter. Thus, the non-functional evaluation means 207 may output a plurality of evaluation results of the non-functional factor of the system to be developed, at a given degree of progress. The evaluation results output by the non-functional evaluation means 207 include, for example, information on whether the value of the non-functional requirement input by the non-functional requirement input means 208 is in the range between the upper limit value and the lower limit value of the non-functional evaluation parameter, included in the adjusted non-functional evaluation parameter.

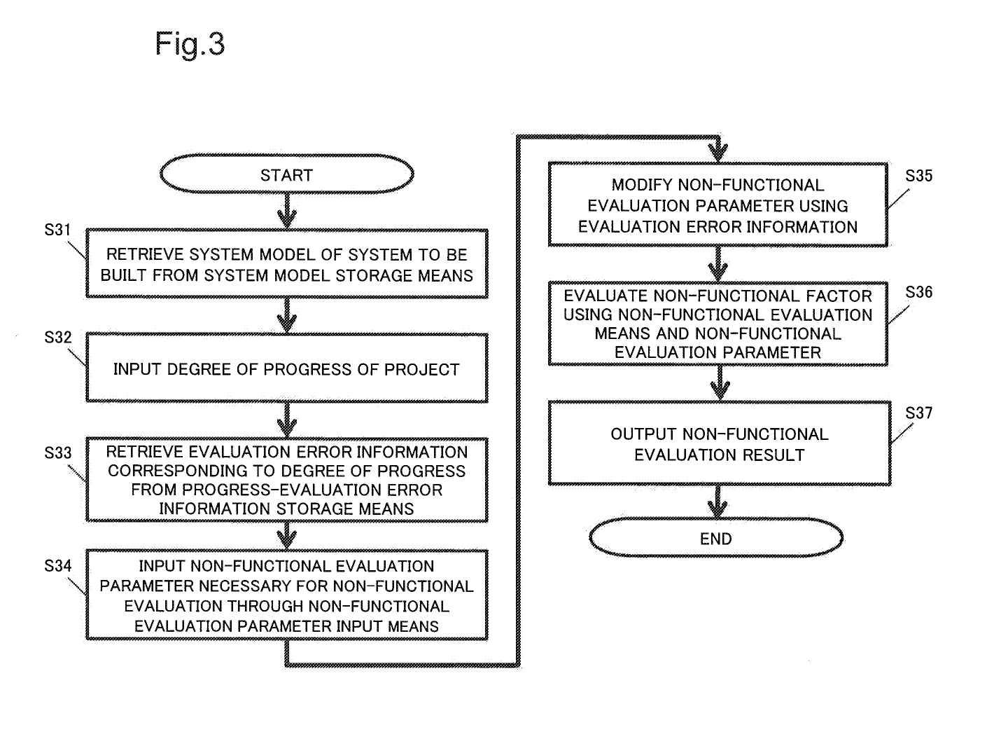

Referring now to the flowchart of FIG. 3, the overall operation of the project management system 2 according to this exemplary embodiment will be described in details.

First, at Step S31 the system model selection means 202 retrieves the system model of the system to be developed at the project from the system model storage means 201. The non-functional requirement input means 208 receives an input of the non-functional requirement (target value of the non-functional parameter) of the system to be developed. At Step S32, An input of the degree of progress of the project is received through the progress input means 204.

At Step S33, the non-functional evaluation parameter adjustment means 206 retrieves the progress-evaluation error information corresponding to the degree of progress input at Step S32, from the progress-evaluation error information storage means 205.

At Step S34, the non-functional evaluation parameter input means 203 receives an input of the non-functional evaluation parameter necessary for the non-functional evaluation, according to the system model retrieved at Step S31. The non-functional evaluation parameter is a property value designated in the system model. The non-functional evaluation parameter includes, for example, information representing the behavior of the user or the system containing at least one of CPU load, disk usage, the number of users, the number of requests, and so forth. In addition, values actually measured at each stage of the progress of the project may be included in the mentioned information.

At Step S35, the non-functional evaluation parameter adjustment means 206 modifies the value of the non-functional evaluation parameter input at Step S34, using the progress-evaluation error information retrieved at Step S33. To modify the value of the non-functional evaluation parameter, for example the value of the non-functional evaluation parameter may be multiplied by the value indicated by the progress-evaluation error information which is regarded as the error ratio as it is, and the non-functional evaluation parameter may be increased or decreased with the multiplied value. Alternatively, the non-functional evaluation parameter may be increased or decreased using probability distribution indicated in the progress-evaluation error information.

At Step S36, the non-functional evaluation means 207 evaluates the non-functional factor of the system to be constructed, based on the non-functional evaluation parameter adjusted at Step S35 and the system model and the non-functional requirement retrieved at Step S31. At this step, a plurality of parameters (e.g., increased values and decreased value of the non-functional evaluation parameter) may be employed as adjusted non-functional evaluation parameter to evaluate the non-functional factor.

At Step S37, the non-functional evaluation means 207 (or a output device not illustrated) outputs and displays the non-functional evaluation result obtained at Step S36. At this step, the degree of progress and the value of the non-functional evaluation parameter varied according to the degree of progress may also be displayed.

As described thus far, the project management system 2 according to this exemplary embodiment is configured to retrieve the progress-evaluation error information corresponding to the degree of progress of the project, modify the non-functional evaluation parameter based on the progress-evaluation error information, and perform the non-functional evaluation taking the error at the corresponding degree of progress of the project into consideration. Therefore, risk of the project can be properly recognized.

### Second Exemplary Embodiment

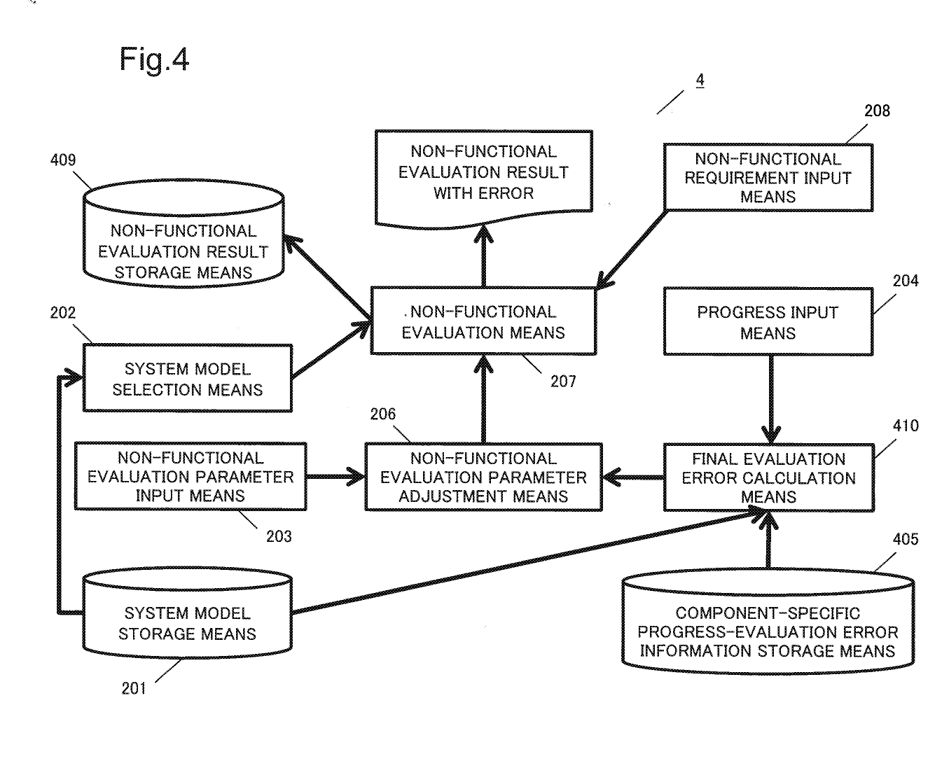

Hereunder, a second exemplary embodiment of the present invention will be described in details, with reference to the drawings. FIG. 4 illustrates a configuration of the project management system according to the second exemplary embodiment. The project management system 4 includes a component-specific progress-evaluation error information storage means 405 in place of the progress-evaluation error storage means 205 of the project management system 2. Further, the project management system 4 includes a non-functional evaluation result storage means 409 and a final evaluation error calculation means 410, in addition to the configuration of the project management system 2 according to the first exemplary embodiment.

The component-specific progress-evaluation error information storage means 405 stores progress-evaluation error information about each component including one or more processes and devices specified in the system model.

The non-functional evaluation result storage means 409 stores the non-functional evaluation result provided by the non-functional evaluation means 207. The non-functional evaluation result storage means 409 stores one or more non-functional evaluation results evaluated with one or more non-functional evaluation parameters including one or more degrees of progress.

The final evaluation error calculation means 410 calculates the component-specific progress-evaluation error and the progress-evaluation error of the whole system to be developed. The component-specific progress-evaluation error is the progress-evaluation error of each of the components included in the system, and calculated based on the information on dependency among the components in the system model, the component-specific progress-evaluation error information, and the component-specific degree of progress. The progress-evaluation error of whole system to be developed is the evaluation error that is obtained when the components are combined to build up the system.

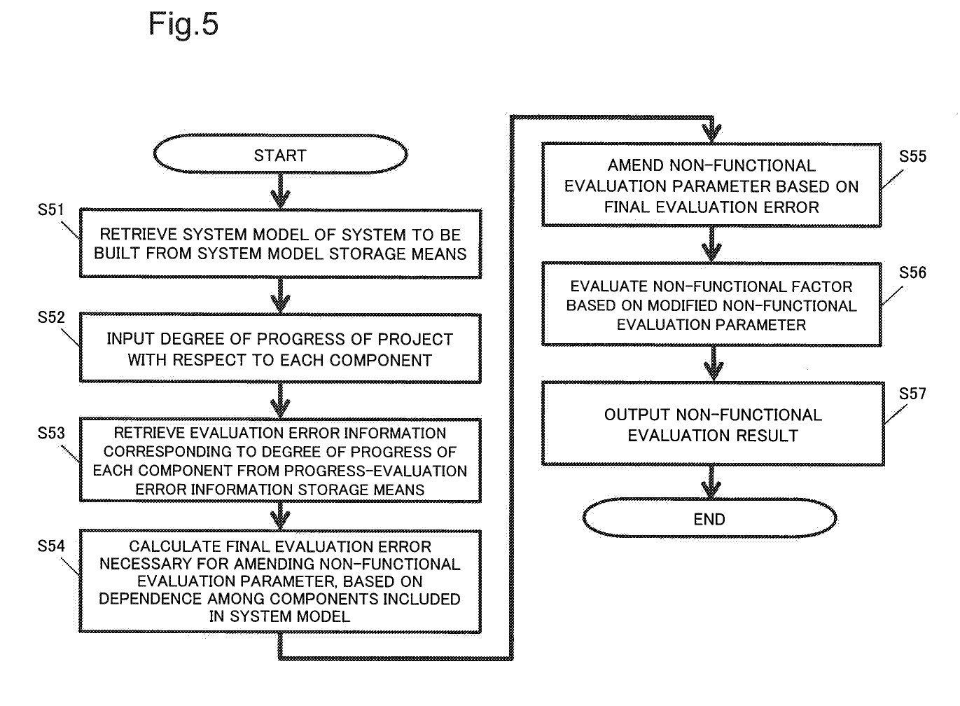

Referring to the flowchart of FIG. 5, the overall operation of the project management system 4 according to this exemplary embodiment will be described in details.

First, the system model selection means 202 retrieves the system model of the system to be developed from the system model storage means 201 (Step S51). Then the progress input means 204 receives an input of progress of each of the components (Step S52). The final evaluation error calculation means 410 retrieves the evaluation error information corresponding to the degree of progress of each component, from the component-specific progress-evaluation error information storage means 405 (Step S53). The final evaluation error calculation means 410 then calculates the final error of the whole system based on the evaluation error information retrieved from the component-specific progress-evaluation error information storage means 405 and the dependency among the components included in the system model (Step S54). Then, the non-functional evaluation parameter adjustment means 206 adjusts the non-functional evaluation parameter based on the final error calculated at Step S53 (Step S55). The non-functional evaluation means 207 evaluates the non-functional factor based on the adjusted non-functional evaluation parameter (Step S56). Finally, the non-functional evaluation means 207 presents the calculated non-functional evaluation result (Step S57).

As described above, the project management system according to this exemplary embodiment is configured to perform the non-functional evaluation in which the non-functional evaluation error of the whole system is reflected based on the component-specific degree of progress and the system configuration, in addition to the configuration according to the first exemplary embodiment. Thus, the risk to the project originating from all the degree of progress of the plurality of components can be evaluated. The components are usually divided into functions when managed, the non-functional requirement of the user includes such factors that have to be evaluated with respect to the entirety of the system. Therefore, it is advantageous to perform the non-functional evaluation as above with respect to the combination of all the components constituting the system.

Further, the non-functional error information of the whole system is calculated based on the system model utilizing the error information of the plurality of components. Therefore, impact to be imposed on the finished non-functional factor can be evaluated, despite the progress of each of the components being different.

### Third Exemplary Embodiment

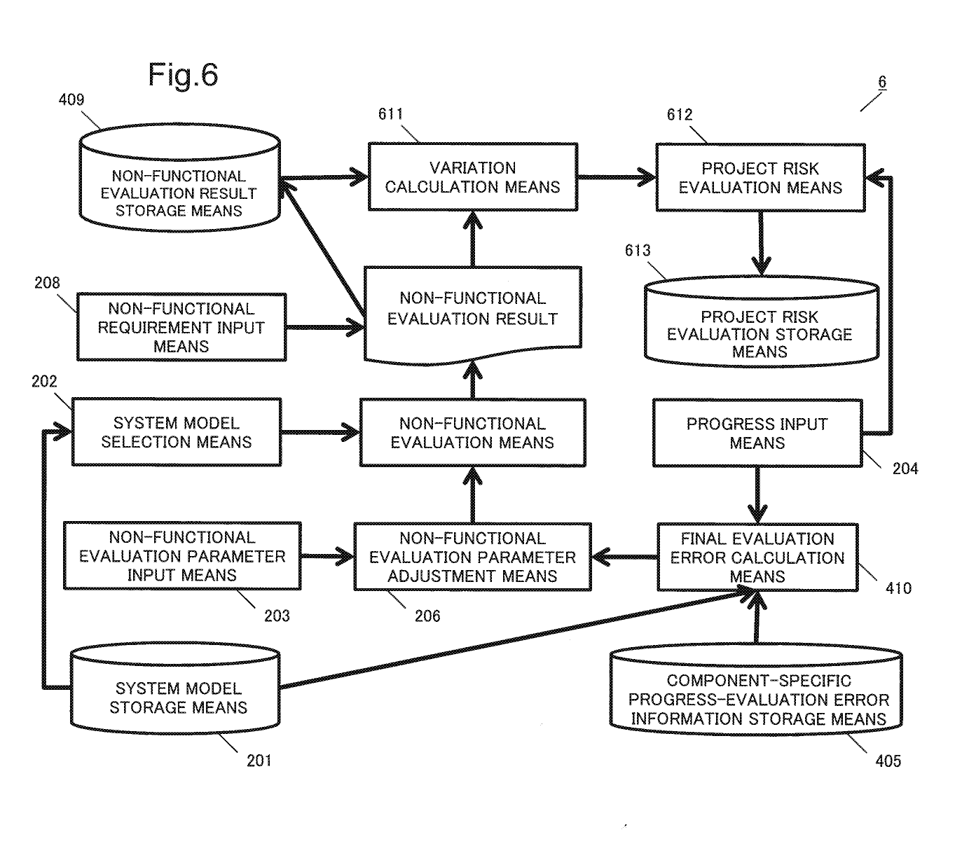

Hereunder, a third exemplary embodiment of the present invention will be described in details, with reference to the drawings. FIG. 6 illustrates a configuration of the project management system according to the third exemplary embodiment. The project management system 6 is different from the project management system according to the first and second exemplary embodiments in including a variation calculation means 611, a project risk evaluation means 612, and a project risk evaluation storage means 613.

The variation calculation means 611 calculates variation of the non-functional evaluation result at each stage of the progress of the project.

For example, the variation calculation means 611 calculates a difference between the non-functional evaluation result adjusted by the non-functional evaluation parameter adjustment means 206 with respect to the current degree of progress, and the non-functional evaluation result adjusted by the non-functional evaluation parameter adjustment means 206 with respect to the preceding degree of progress. Alternatively, the variation calculation means 611 may calculate a difference between the unadjusted non-functional evaluation result with respect to the current degree of progress and the unadjusted non-functional evaluation result with respect to the preceding degree of progress.

The project risk evaluation means 612 calculates a risk evaluation value of the project based on the variation calculated by the variation calculation means 611 and the degree of progress. The project risk evaluation storage means 613 stores the project risk evaluation value calculated by the project risk evaluation means 612. Examples of the project risk evaluation value will be subsequently described.

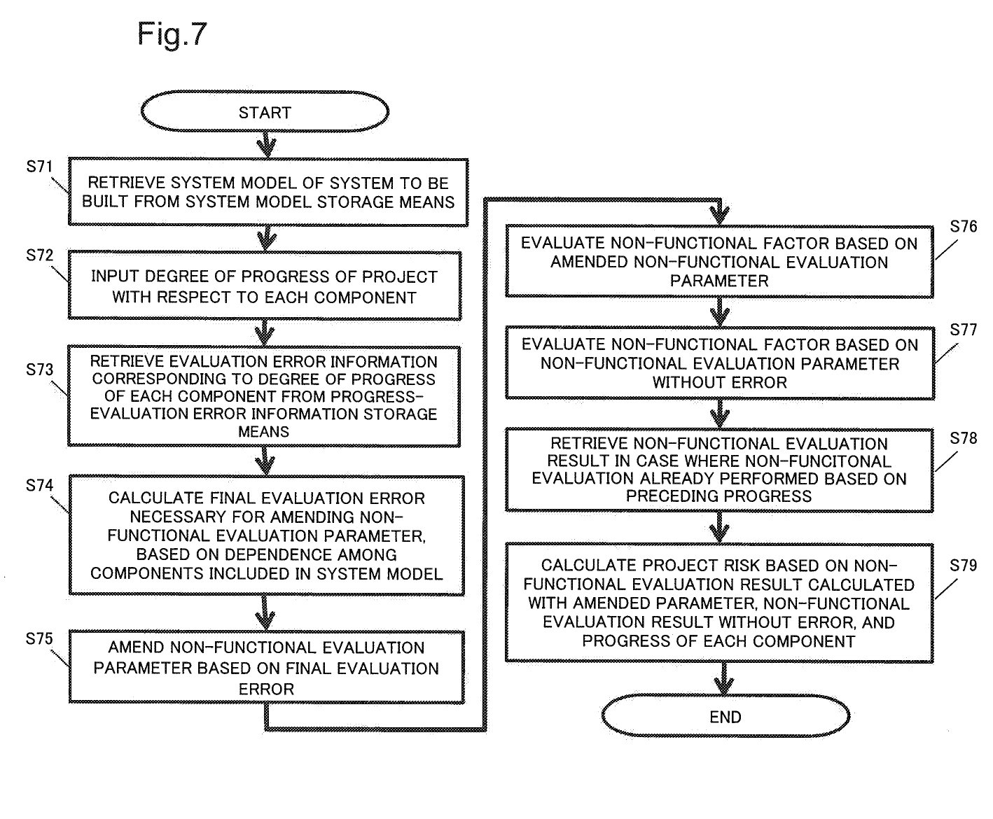

Referring to the flowchart of FIG. 7, the overall operation of the project management system 6 according to this exemplary embodiment will be described in details.

First, system model selection means 202 retrieves the system model of the system to be developed by the project from the system model storage means 201 (Step S71). Then the progress input means 204 receives an input of the progress of each of the components (Step S72). The final evaluation error calculation means 410 retrieves the evaluation error information corresponding to the degree of progress of each component, from the component-specific progress-evaluation error information storage means 405 (Step S73). The final evaluation error calculation means 410 then calculates the final error of the whole system based on the component-specific progress-evaluation error information retrieved from the component-specific progress-evaluation error information storage means 405 and the dependency among the components included in the system model (Step S74). Then, the non-functional evaluation parameter adjustment means 206 adjusts (modifies) the non-functional evaluation parameter based on the final error calculated as above (Step S75). The non-functional evaluation means 207 evaluates the non-functional factor based on adjusted (modified) non-functional evaluation parameter. Then, the non-functional evaluation means 207 evaluates the non-functional factor based on the non-functional evaluation parameter before the adjustment (modification), and stores the evaluation result in the non-functional evaluation result storage means 409. In the case where the non-functional evaluation has already been performed at a preceding degree of progress, the variation calculation means 611 retrieves the stored non-functional evaluation result corresponding to the preceding degree of progress, from the non-functional evaluation result storage means 409. Further, the variation calculation means 611 calculates a difference between the non-functional evaluation result thus retrieved and the non-functional evaluation result based on the current degree of progress. The variation calculation means 611 then calculates the risk value based on the difference calculated as above, and stores the calculation result in the project risk evaluation storage means 613.

As described above, the project management system according to this exemplary embodiment is configured to calculate the project risk value based on the non-functional evaluation result, in addition to the configuration according to the first and second exemplary embodiments. Thus, the risk of the project associated with the non-functional factor can be recognized, thereby management of the project based on the non-functional factor can be performed.

### EXAMPLES

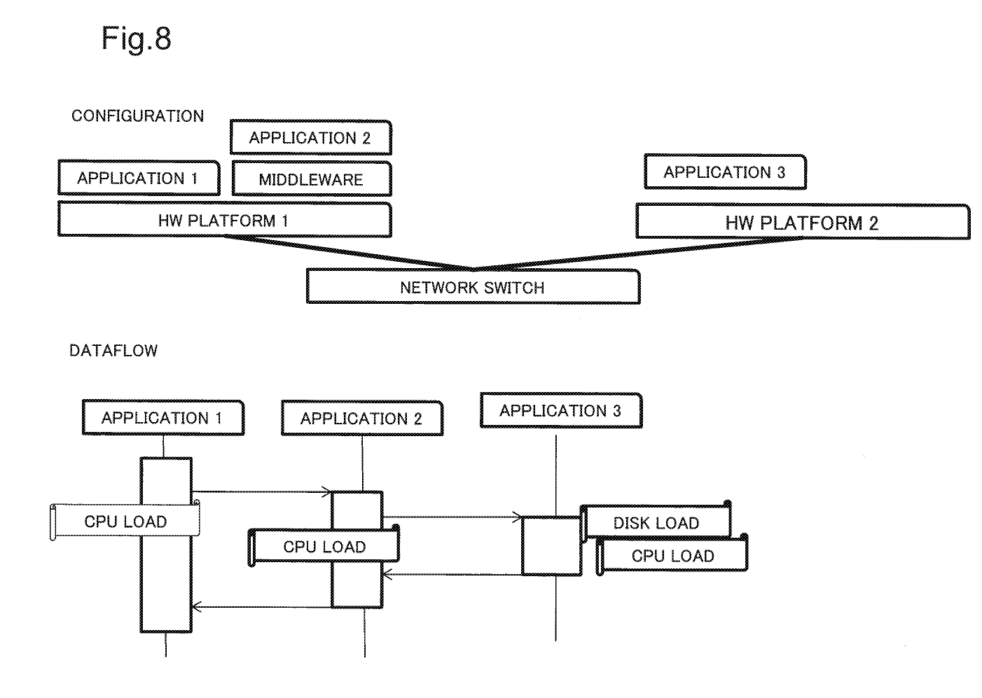

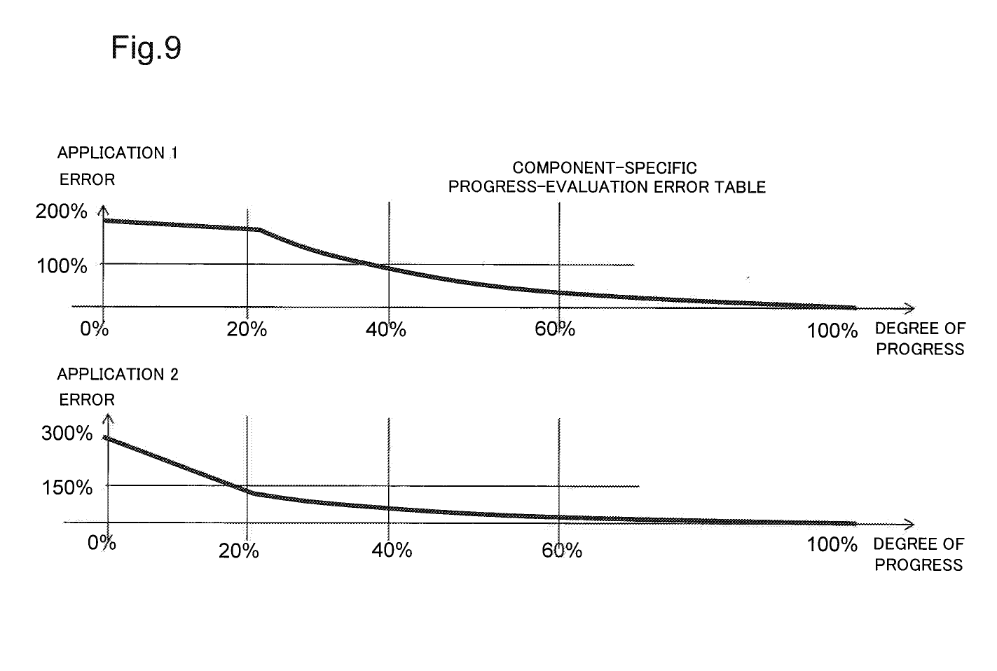

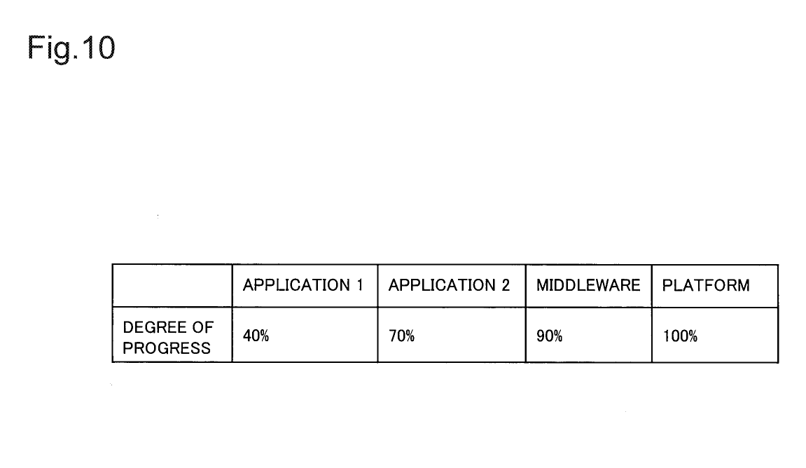

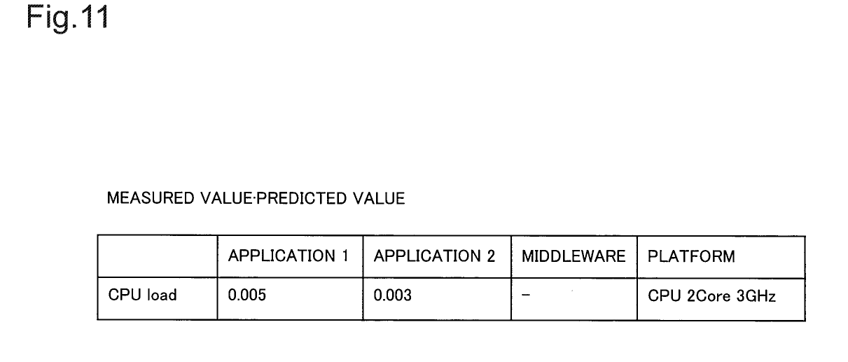

The operation according to the exemplary embodiments of the present invention will be described with reference to specific examples. A construction of a system based on a system model illustrated in FIG. 8 will be used as an example. Functions shown in FIG. 9 are given as component-specific progress-error information of the system. In addition, the component-specific progress shown in FIG. 10 is input through the progress input means. Further, application information such as measured values or predicted values, and a sizing factor shown in FIG. 11 are input or measured as non-functional evaluation parameters.

Next, the non-functional evaluation parameter adjustment means calculates an error of the input non-functional evaluation parameter based on the progress and the system model. In this example, the error is calculated as (100-degree of progress), to simplify the calculation. The degree of progress may be given to the progress-evaluation error information and the corresponding error may be retrieved, to employ the retrieved value as the error. In order to adjust the non-functional evaluation parameter of the application 1, first a component with which the application 1 is associated (which the application 1 depends on or is connected to) is identified. Here, in view of the configuration of the system model shown in FIG. 8, it is understood that the application 1 is directly implemented on the HW platform 1. Accordingly, no other component exists which the application 1 depends on. Although range of the dependency is limited within the HW platform 1 in this example, middleware connected through a network or implemented on the HW platform 1 may also be included. In such case, a coefficient based on the difference in degree of dependency of the component may be incorporated when the final error information is calculated.

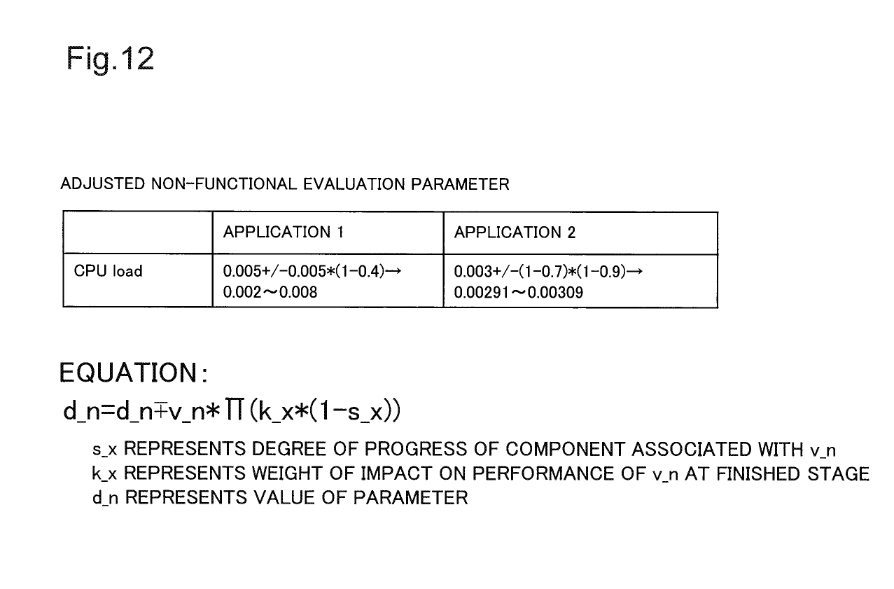

In this example, the associated components are limited to those implemented on the HW platform 1 and provided hierarchical relationship, and the adjusted non-functional evaluation parameter (in this example, CPU load) of the application 1 is calculated using the equation cited in FIG. 12. As a result of the calculation, values of 0.002 to 0.008 are obtained as shown in the table of FIG. 12. Regarding the application 2, likewise, upon making calculation according to the equation of FIG. 12 using the progress information of each component shown in FIG. 10 (in this example, 70% of the application 2 and 90% of the middleware) with respect to the associated component (in this example, the middleware), the adjusted non-functional evaluation parameters can be obtained as 0.00291 to 0.00309 as shown in the table of FIG. 12.

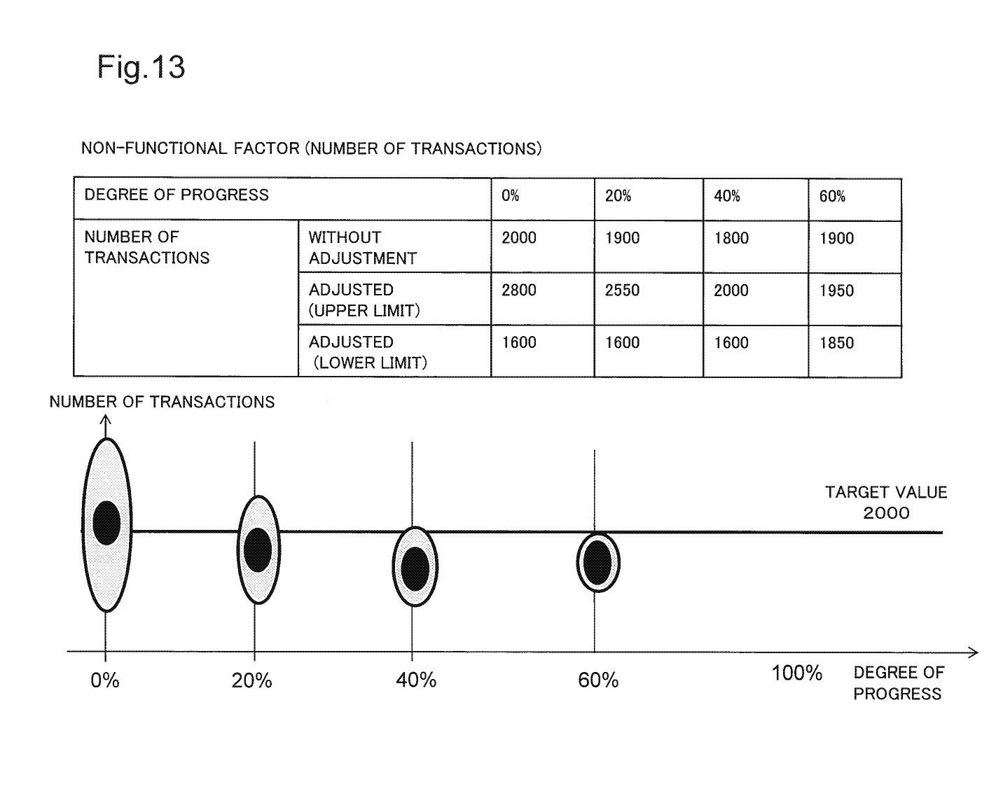

The non-functional requirement is then calculated using the mentioned values. The non-functional requirement can be calculated, for example, by the method described in “Izukura, Applying a Model-Based Approach to IT Systems Development Using SysML Extension. 563-577 MoDELS” (https://springerlink3.metapress.com/content/f6nk805878537062/resource-secured/?target =fulltext.pdf&sid=0hw2rjxkzjegijpb4hcnd341&sh=www.sp ringerlink.com). FIG. 13 represents the evaluation result of the number of transactions, which is one of the non-functional factors, obtained with the unadjusted non-functional evaluation parameter, the adjusted upper limit value, and the adjusted lower limit value. FIG. 13 represents the result corresponding to each degree of progress. In addition, the unadjusted value (median), the upper limit value, and the lower limit value are indicated in the diagram in the lower part of FIG. 13, which facilitates the difference from the target value to be recognized, thereby enabling the project management to be performed with high-accuracy.

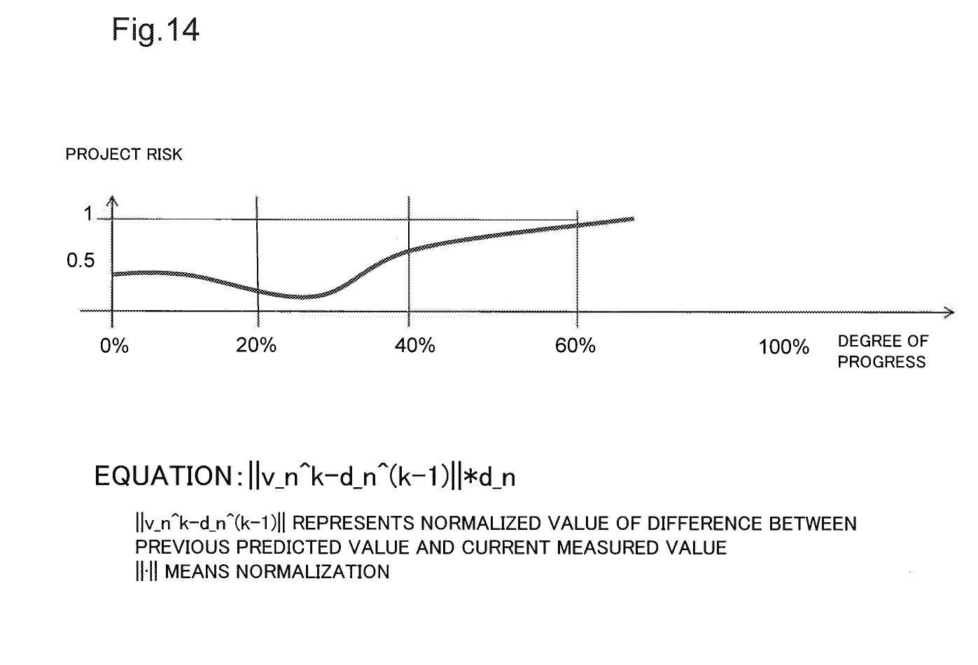

Further, FIG. 14 represents the calculation result of the risk value obtained by substituting the mentioned values in the equation cited in FIG. 14. In view of FIG. 14, it can be easily recognized that the possibility of satisfying the target value is decreasing and that the risk of the project is increasing, with the progress of the project.

This application claims priority based on Japanese Patent Application No. 2013-027088 filed on Feb. 14, 2013, the entire content of which is incorporated hereinto by reference.

Although a part or the whole of the foregoing exemplary embodiments may be described as Supplementary Notes cited hereunder, the present invention is in no way limited to the Supplementary Notes. It is obvious to those skilled in the art that various modifications may be made to the configuration and details of the present invention within the scope of the present invention.

### Supplementary Note 1

A project management system including:

a storage means for storing information of error that may be generated between a non-functional evaluation value of a system in an unfinished stage and a non-functional requirement of the finished system, as evaluation error information with respect to each degree of progress of the project;

a system model acquisition means for acquiring a system model of the system;

a non-functional requirement acquisition means for acquiring the non-functional requirement of the system;

a progress input means for inputting the degree of progress of the project;

a non-functional evaluation parameter input means for inputting a non-functional evaluation parameter of the system corresponding to the degree of progress input;

a non-functional evaluation parameter adjustment means for adjusting the input non-functional evaluation parameter with the stored evaluation error information corresponding to the input degree of progress; and

a non-functional evaluation means for evaluating a non-functional factor of the system at the input degree of progress, on a basis of the adjusted non-functional evaluation parameter, the acquired system model, and the acquired non-functional requirement.

### Supplementary Note 2

The project management system according to Supplementary Note 1, in which the non-functional evaluation means further evaluates the non-functional factor of the system at the input degree of progress using the unadjusted non-functional evaluation parameter and the acquired system model and the non-functional requirement, and outputs a plurality of evaluation results of the non-functional factor of the system.

### Supplementary Note 3

The project management system according to Supplementary Notes 1 or 2, wherein

the progress input means inputs the degree of progress of the project with respect to each of a plurality of components included in the system,

the non-functional evaluation parameter adjustment means adjusts the non-functional evaluation parameter of the system including the plurality of the components corresponding to the input degree of progress, using dependence among the components, the degree of progress input with respect to each of the components, and the evaluation error information on each of the components, and

the non-functional evaluation means evaluates the non-functional factor of the system corresponding to the input degree of progress, using the adjusted non-functional evaluation parameter of the system including the plurality of components, the acquired system model and the non-functional requirement of the system.

### Supplementary Note 4

The project management system according to any one of Supplementary Notes 1 to 3, further including

a project risk evaluation means for calculating risk of the project on a basis of variation between evaluation results provided by the non-functional evaluation means, respectively corresponding to different degrees of progress.

### Supplementary Note 5

The project management system according to any one of Supplementary Notes 1 to 4, wherein

the adjusted non-functional evaluation parameter includes information of an upper limit value and a lower limit value that the non-functional evaluation parameter may assume when the system is completed, and

the evaluation result provided by the non-functional evaluation means includes information on whether the value of the acquired non-functional requirement is in a range between the upper limit value and the lower limit value.

### Supplementary Note 6

The project management system according to any one of Supplementary Notes 1 to 5, wherein

the evaluation error information contains information of at least one of a function and probability distribution.

### Supplementary Note 7

A project management method executed by an information processing system including a control unit, including:

a storing step for storing, in the control unit, information of error that may be generated between a non-functional evaluation value of a system in an unfinished stage and a non-functional requirement of the finished system, as evaluation error information with respect to each degree of progress of the project;

a system model acquisition step for acquiring a system model of the system;

a non-functional requirement acquisition step for acquiring the non-functional requirement of the system;

a progress input step for inputting the degree of progress of the project in the control unit;

a non-functional evaluation parameter input step for inputting in the control unit a non-functional evaluation parameter of the system corresponding to the degree of progress input;

a non-functional evaluation parameter adjustment step for causing the control unit to adjust the input non-functional evaluation parameter with the stored evaluation error information corresponding to the input degree of progress; and

a non-functional evaluation step for causing the control unit to evaluate a non-functional factor of the system at the input degree of progress, on the basis of the adjusted non-functional evaluation parameter, the acquired system model, and the acquired non-functional requirement.

### Supplementary Note 8

A program that causes a computer to perform as:

a storage means for storing information of error that may be generated between a non-functional evaluation value of a system in an unfinished stage and a non-functional requirement of the finished system, as evaluation error information with respect to each degree of progress of the project;

a system model acquisition means for acquiring a system model of the system;

a non-functional requirement acquisition means for acquiring the non-functional requirement of the system;

a progress input means for inputting the degree of progress of the project;

a non-functional evaluation parameter input means for inputting a non-functional evaluation parameter of the system corresponding to the degree of progress input;

a non-functional evaluation parameter adjustment means for adjusting the input non-functional evaluation parameter with the stored evaluation error information corresponding to the input degree of progress; and

a non-functional evaluation means for evaluating a non-functional factor of the system at the input degree of progress, on the basis of the adjusted non-functional evaluation parameter, the acquired system model, and the acquired non-functional requirement.

What is claimed is:

1. A project management system comprising:
a storage unit configured to store information of error that may be generated between a non-functional evaluation value of a system in an unfinished stage and a non-functional requirement of the finished system, as evaluation error information with respect to each degree of progress of the project;
a system model acquisition unit configured to acquire a system model of the system;
a non-functional requirement acquisition unit configured to acquire the non-functional requirement of the system;
a progress input unit configured to input the degree of progress of the project;
a non-functional evaluation parameter input unit configured to input a non-functional evaluation parameter of the system corresponding to the degree of progress input;
a non-functional evaluation parameter adjustment unit configured to adjust the input non-functional evaluation parameter with the stored evaluation error information corresponding to the input degree of progress; and
a non-functional evaluation unit configured to evaluate a non-functional factor of the system at the input degree of progress based on the adjusted non-functional evaluation parameter, the acquired system model and the acquired non-functional requirement.

2. The project management system according to claim 1, wherein
the non-functional evaluation unit further configured to evaluate the non-functional factor of the system at the input degree of progress using the unadjusted non-functional evaluation parameter and the acquired system model and the non-functional requirement, and outputs a plurality of evaluation results of the non-functional factor of the system.

3. The project management system according to claim 1, wherein
the progress input unit inputs the degree of progress of the project with respect to each of a plurality of components included in the system,
the non-functional evaluation parameter adjustment unit adjusts the non-functional evaluation parameter of the system including the plurality of the components corresponding to the input degree of progress, using dependence among the components, the degree of progress input with respect to each of the components, and the evaluation error information on each of the components, and
the non-functional evaluation unit evaluates the non-functional factor of the system corresponding to the input degree of progress, using the adjusted non-functional evaluation parameter of the system including the plurality of components, the acquired system model and the non-functional requirement of the system.

4. The project management system according to claim 1 further comprising:
a project risk evaluation unit configured to calculate risk of the project on a basis of variation between evaluation results provided by the non-functional evaluation unit, respectively corresponding to different degrees of progress.

5. The project management system according to claim 1 wherein
the adjusted non-functional evaluation parameter includes information of an upper limit value and a lower limit value that the non-functional evaluation parameter may assume when the system is completed, and
the evaluation result provided by the non-functional evaluation unit includes information on whether the value of the acquired non-functional requirement is in a range between the upper limit value and the lower limit value.

6. The project management system according to claim 1 wherein
the evaluation error information contains information of at least one of a function and probability distribution.

7. A project management method executed by an information processing system including a control unit, comprising:
storing, in the control unit, information of error that may be generated between a non-functional evaluation value of a system in an unfinished stage and a non-functional requirement of the finished system, as evaluation error information with respect to each degree of progress of the project;
acquiring a system model of the system;
acquiring the non-functional requirement of the system;
inputting the degree of progress of the project in the control unit;
inputting in the control unit a non-functional evaluation parameter of the system corresponding to the degree of progress input;
causing the control unit to adjust the input non-functional evaluation parameter with the stored evaluation error information corresponding to the input degree of progress; and
causing the control unit to evaluate a non-functional factor of the system at the input degree of progress based on the adjusted non-functional evaluation parameter, the acquired system model and the acquired non-functional requirement.

8. A program that causes a computer to perform as:
a storage unit configured to store information of error that may be generated between a non-functional evaluation value of a system in an unfinished stage and a non-functional requirement of the finished system, as evaluation error information with respect to each degree of progress of the project;
a system model acquisition unit configured to acquire a system model of the system;
a non-functional requirement acquisition unit configured to acquire the non-functional requirement of the system;
a progress input unit configured to input the degree of progress of the project;
a non-functional evaluation parameter input unit configured to input a non-functional evaluation parameter of the system corresponding to the degree of progress input;
a non-functional evaluation parameter adjustment unit configured to adjust the input non-functional evaluation parameter with the stored evaluation error information corresponding to the input degree of progress; and
a non-functional evaluation unit configured to evaluate a non-functional factor of the system at the input degree of progress based on the adjusted non-functional evaluation parameter, the acquired system model and the acquired non-functional requirement.
